(19) United States
(12) Patent Application Publication
(10) Pub. No.: US 2016/0040693 A1
(43) Pub. Date: Feb. 11, 2016

(54) MAGNET FASTENER AND METHOD OF ELIMINATING TICKING AND RATTLING IN A MAGNET FASTENER

(71) Applicant: FORD GLOBAL TECHNOLOGIES, LLC, Dearborn, MI (US)

(72) Inventors: Mike Popovski, Utica, MI (US); David Huelke, Milan, MI (US)

(21) Appl. No.: 14/453,910

(22) Filed: Aug. 7, 2014

(51) Int. Cl. F16B 1/00; B60R 13/02

(52) U.S. Cl. CPC F16B 1/00; B60R 13/02; B60R 13/0212; F16B 2001/0035

(57) ABSTRACT

A magnet fastener includes a carrier having a unitary body with a base, a magnet support and a resilient shaft extending between the base and the magnet support. The magnet fastener also includes a magnet that is fixed to the magnet support. Advantageously the resilient shaft allows articulation the magnet support and magnet on the base without any ticking or rattling.

### TECHNICAL FIELD

This document relates generally to the fastener field and, more particularly, to a magnet fastener having a unitary base that essentially eliminates ticking and rattling.

### BACKGROUND

Magnet fasteners or clips are well known in the art and are often utilized to fasten body panels and automobile interior trim piece panels, such as a headliner, to the body or chassis of a vehicle. Such fasteners must allow for articulation in order to accommodate manufacturing tolerances and/or irregular body contours so as to provide proper fastening.

U.S. Pat. Nos. 7,306,190 and 8,287,034 disclose state-of-the-art magnet fasteners. The '190 patent relates to a fastener including a magnet that is held in a carrier that is loosely fitted onto a post in order to allow for tilt or articulation as often required to provide substantially flush engagement against a substrate such as a roof to which a trim piece is to be mounted.

Similarly, the '034 patent discloses a magnet mounted in a holder that is captured on a boss. A gap is provided between the boss and the holder so as to allow relative movement of the holder on the boss and articulation of the magnet.

It should be appreciated that the magnet holders disclosed in the '190 and '034 patents are made of multiple pieces that move relative to each other in order to provide articulation. These devices must be carefully manufactured under tight tolerances to allow proper assembly and operation. Even when properly manufactured, the relative movement of the parts may lead to a ticking or rattling sound that can be particularly annoying to a vehicle operator. When one realizes that these fasteners are often utilized to attach a headliner to the vehicle roof, it is appreciated that this ticking or rattling occurs in the proximity of the ears of the vehicle occupants. Often the ticking or rattling is so annoying the dissatisfied vehicle operator brings the vehicle in for service to address and prevent the unwanted sound. The removal and replacement of a headliner is a time-consuming and costly repair. Further, the resulting customer dissatisfaction of the operator with the vehicle brand is a critical concern.

This document relates to a new and improved magnet fastener of unitary construction which substantially eliminates any possibility of the fastener ticking or rattling when in use.

### SUMMARY

In accordance with the purposes and benefits described herein, a magnet fastener comprises a carrier including a unitary body having a base, a magnet support and a resilient shaft extending between the base and the magnet support. The magnet fastener further includes a magnet fixed to the magnet support whereby the resilient shaft allows articulation of the magnet support and magnet on the base without any ticking or rattling sound.

In one possible embodiment, the unitary or single-piece body is made from plastic. That plastic may be selected from the group of materials consisting of polypropylene and ABS. In one possible embodiment the resilient shaft has a circular cross-section with a diameter between 2.0 mm and 3.0 mm.

Still further, in one possible embodiment the cup is made from a ferromagnetic material. In one possible embodiment, the magnetic support comprises a cavity that receives and holds the cup. In one possible embodiment, the cup is over molded with the unitary body. The magnet is received and held in the cup by the force of magnetic attraction.

In one possible embodiment, the cup includes a central aperture and a stem of the unitary body extends through and completely fills that aperture. Further the unitary body includes a fastener on an end of the stem that captures the cup on the stem and prevents any movement between the cup and the unitary body. Still further the magnet is annular in shape and includes an opening received around the fastener.

In accordance with an additional aspect, the magnet fastener may be described as comprising a magnet, a ferromagnetic cup holding the magnet and a plastic base over molded to the cup. That plastic base includes a resilient shaft to allow for articulation of the magnet. That resilient shaft has a circular cross-section with a diameter of between 2.0 mm and 3.0 mm.

In accordance with yet another aspect, a method of eliminating ticking and rattling in a magnet fastener including a magnet, a ferromagnetic cup holding the magnet and a molded single piece base is provided. That method comprises the steps of over molding the cup with the base and providing the base with a resilient shaft to allow the magnet to articulate so as to make a better connection with a substrate to which the magnet is to be connected.

In the following description, there is shown and described several preferred embodiments of the magnet fastener. As it should be realized, the magnet fastener is capable of other, different embodiments and its several details are capable of modification in various, obvious aspects all without departing from the magnet fastener as set forth and described in the following claims. Accordingly, the drawings and descriptions should be regarded as illustrative in nature and not as restrictive.

### BRIEF DESCRIPTION OF THE DRAWINGS

The accompanying drawings incorporated herein and forming a part of the specification, illustrate several aspects of the magnet fastener and together with the description serve to explain certain principles thereof. In the drawings:

FIG. 1 is an exploded perspective view of the magnet fastener.

FIG. 2 is a detailed perspective view of the single-piece carrier portion of the magnet fastener.

FIG. 3 is a cross-sectional view of the fully assembled magnet fastener.

FIG. 4 is a fragmentary detailed cross-sectional view illustrating how the fastener is utilized to attach a headliner to the roof of a vehicle.

Reference will now be made in detail to the present preferred embodiments of the magnet fastener, examples of which are illustrated in the accompanying drawings.

### DETAILED DESCRIPTION

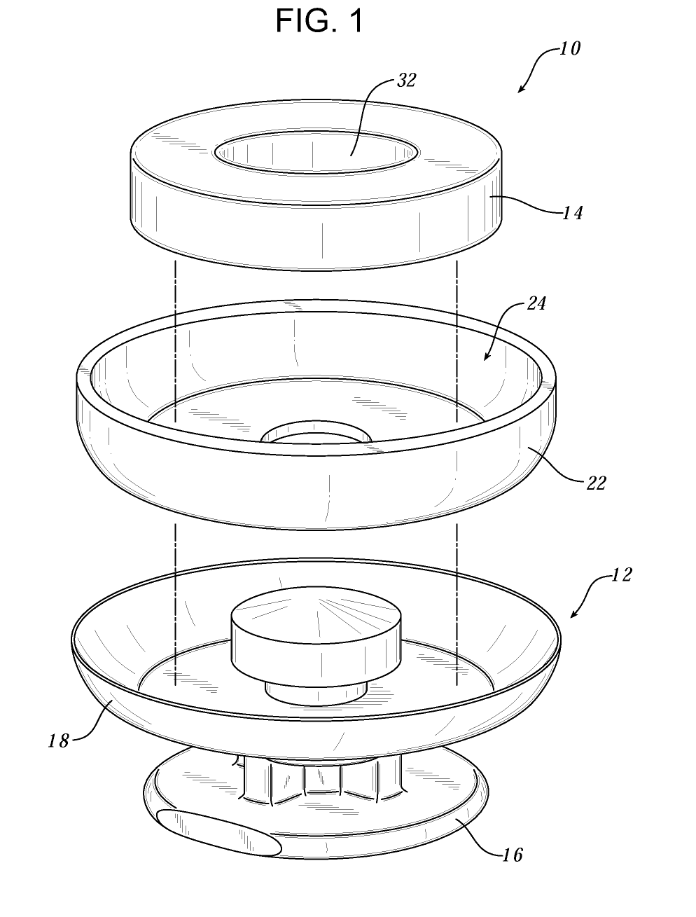

Reference is now made to FIGS. 1-3 illustrating the magnet fastener 10 that includes a carrier 12 and a magnet 14. More specifically, the carrier 12 includes a unitary or single-piece body having a base 16, a magnet support 18 and a resilient shaft 20 extending between the base and the magnet support. As will be described in greater detail below the magnet 14 is fixed to the magnet support 18 and the resilient shaft allows articulation of the magnet support and the magnet on the base 16 without any ticking or rattling.

In one possible embodiment the unitary carrier body 12 is made from a plastic material. In one possible embodiment the unitary carrier body 12 is made from polypropylene. In another possible embodiment, the unitary carrier body 12 is made from ABS. In other embodiments, it is made from other appropriate plastic materials. In one possible embodiment the resilient shaft 20 has a circular cross-section. That cross-section may have a diameter of between 2.0 mm and 3.0 mm. In another possible embodiment that circular cross-section may have a diameter of between 2.25 mm and 2.75 mm. In yet another possible embodiment the circular cross-section may have a diameter of approximately 2.5 mm.

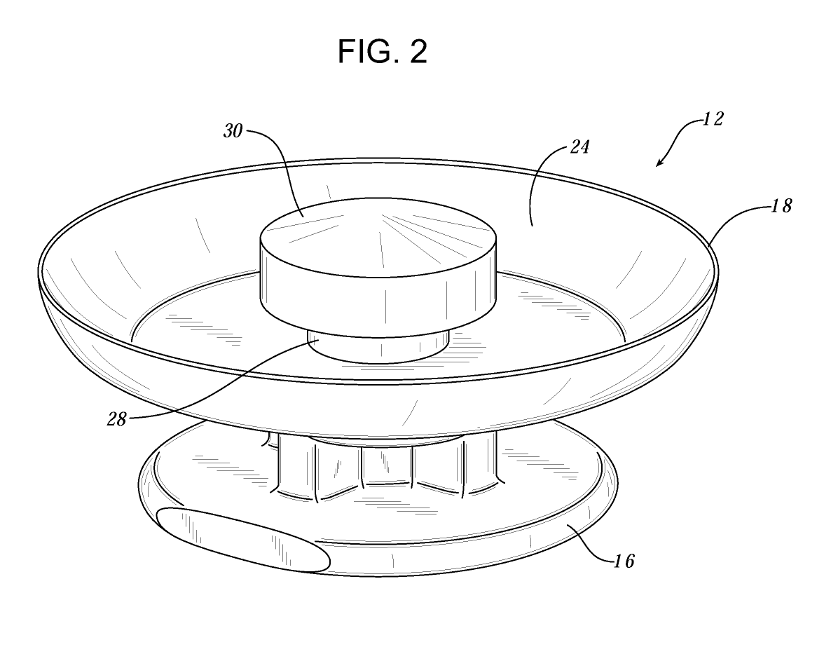

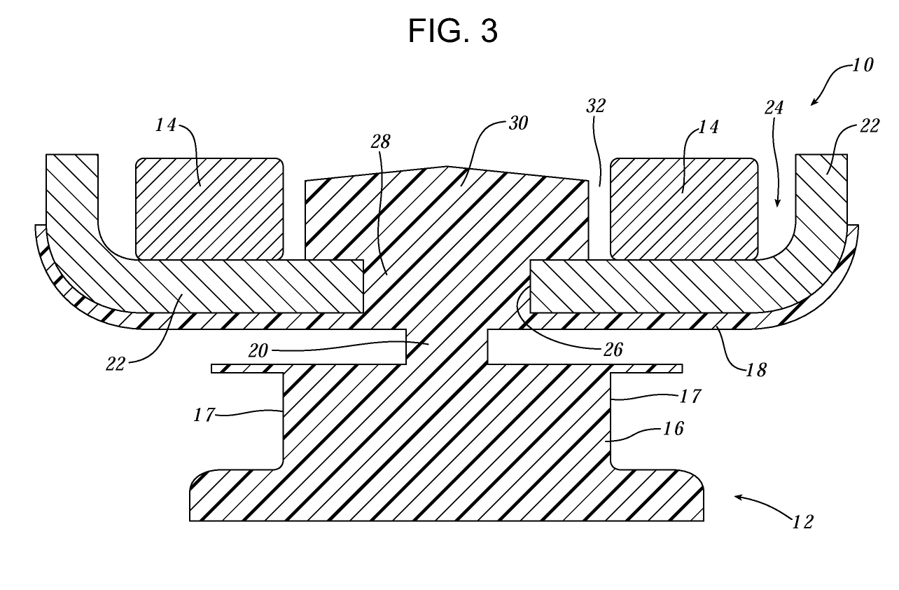

As illustrated in FIGS. 1 and 3, the magnet fastener 10 also includes a cup 22. In one possible embodiment the cup 22 is made from a ferromagnetic material. As best illustrated in FIGS. 2 and 3, the magnet support 18 comprises a bowl shaped cavity 24 having a contour that matches the outer wall of the cup 22 that is received and held in the cavity. In one particularly useful embodiment, the unitary carrier body 12 is over molded onto the cup 22 in accordance with the general principles of over molding that are known in the art. More specifically, as best illustrated in FIG. 3, the cup 22 includes a central aperture 26 and stem 28 of the unitary body extends through to completely fill that aperture. Further the unitary carrier body 12 includes an integral fastener 30 on an end of the stem 28 that captures the cup 22 on the stem and prevents any movement between the cup and the unitary body.

As further illustrated in FIGS. 1 and 3, the magnet 14 is annular in shape and includes an opening 32. When the magnet 14 is mounted in the recess 34 of the cup 22 and held in the cup by the force of magnetic attraction, the opening 32 is received over the integral fastener 30 of the unitary carrier body 12.

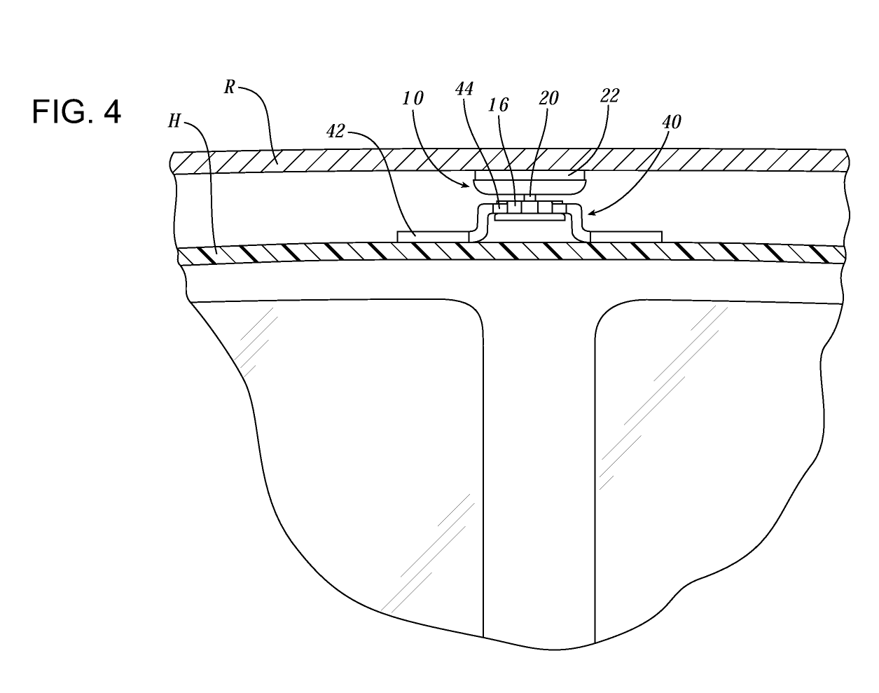

Reference is now made to FIG. 4 which illustrates the magnet fastener 10 in use to hold a headliner H to the roof R of a vehicle. As illustrated, the magnet fastener 10 is secured to the doghouse 40 by sliding the channel or groove 17 in the base 16 into a slot on the mounting boss 44 of the doghouse so as to provide a tight friction fit (see also FIG. 3). The base 42 of the doghouse 40 is then secured with an appropriate adhesive to the headliner H. The headliner H is then positioned relative to the roof R.

More specifically, the magnet 14 held in the cup 22 is used to make a blind connection to the roof R of the vehicle. The thin, resilient shaft 20 allows for any necessary articulation of the cup 22 and magnet 14 held therein to bring the magnet into flush contact with the roof R so as to insure a good connection. While only one magnet fastener 10 is illustrated in FIG. 4, it should be appreciated that more than one may be used when securing the headliner H to the roof R.

While magnet fasteners of the prior art mount the cup or magnet holder loosely on a post or stem of the carrier in order to allow for articulation, it should be appreciated that the cup 22 is over molded by a unitary carrier body 12. This single piece carrier body 12 has a resilient shaft 20 that allows any articulation of the magnet support 18 and magnet 14 carried therein on the base 16 necessary to allow proper connection between the magnet and a desired substrate. Advantageously, this is accomplished while avoiding the free movement between multiple parts that can lead to ticking and rattling commonly associated with prior art magnet fastener designs. As such, the present magnet fastener 10 provides all the desired advantages without the disadvantages of prior art magnet fasteners. Thus, the magnet fastener 10 represents a substantial advance in the art.

In accordance with an additional aspect, a method of eliminating ticking and rattling in a magnet fastener 10 is provided where that magnet fastener includes a magnet 14, a ferromagnetic cup 22 holding the magnet and a molded single-piece carrier 12. That method includes the steps of over molding the cup 22 with the carrier 12 and providing the carrier with a resilient shaft 20 to allow the magnet 14 to articulate so as to make a better connection with the substrate to which the magnet is to be connected.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A magnet fastener, comprising:
a carrier including a unitary body having a base, a magnet support and a resilient shaft extending between said base and said magnet support; and
a magnet fixed to said magnet support whereby said resilient shaft allows articulation of said magnet support and magnet on said base without any ticking or rattling.

2. The fastener of claim 1, wherein said unitary body is made from plastic.

3. The fastener of claim 2, wherein said plastic is selected from a group of materials consisting of polypropylene and ABS.

4. The fastener of claim 3, wherein said resilient shaft has a circular cross-section with a diameter of between 2.0 mm and 3.0 mm.

5. The fastener of claim 4, further including a cup made from a ferromagnetic material.

6. The fastener of claim 5, wherein said magnetic support comprises a cavity that receives and holds said cup.

7. The fastener of claim 6, wherein said cup is over molded with said unitary body.

8. The fastener of claim 7, wherein said magnet is received and held in said cup by force of magnetic attraction.

9. The fastener of claim 8, wherein said cup includes a central aperture and a stem of said unitary body extends through and completely fills said aperture.

10. The fastener of claim 9, wherein said unitary body further includes a fastener on an end of said stem that captures said cup on said stem and prevents any movement between said cup and said unitary body.

11. The fastener of claim 10, wherein said magnet is annular in shape and includes an opening received around said fastener.

12. A magnet fastener, comprising:
a magnet;
a ferromagnetic cup holding said magnet; and
a plastic base over molded to said cup.

13. The fastener of claim 12, wherein said plastic base includes a resilient shaft to allow for articulation of said magnet.

14. The fastener of claim 11, wherein said resilient shaft has a circular cross-section with a diameter of between 2.0 mm and 3.0 mm.

15. A method of eliminating ticking and rattling in a magnet fastener including a magnet, a ferromagnetic cup holding the magnet and a molded single-piece carrier, comprising:
over molding said cup with said carrier; and
providing said carrier with a resilient shaft to allow said magnet to articulate so as to make a better connection with a substrate to which said magnet is to be connected.
